(19) United States
(12) Patent Application Publication
(10) Pub. No.: US 2009/0278928 A1
(43) Pub. Date: Nov. 12, 2009

(54) SIMULATING A FLUTTERING SHUTTER FROM VIDEO DATA

(75) Inventor: Scott McCloskey, Minneapolis, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International Inc.

(21) Appl. No.: 12/126,761

(22) Filed: May 23, 2008

Related U.S. Application Data
(60) Provisional application No. 61/052,147, filed on May 9, 2008.

(51) Int. Cl. H04N 7/18; H04N 5/228

(52) U.S. Cl. 348/143; 348/208.4; 348/E05.031

(57) ABSTRACT

A method and system for simulating a fluttering shutter from video data. Composite images can be generated by adding a sequence of video frames, scaling each according to a weight. By selecting an appropriate sequence of weights, the effects of a fluttering shutter can be synthesized, with the additional flexibility of being able to use negative and non-binary amplitudes. In addition, video analytic functions such as background subtraction and tracking can be used to improve the results of the de-blurring. In particular, the use of background-subtracted frames in generating the composite image prevents background intensities from distorting the de-blurred image. Tracking information can be utilized to estimate the location and speed of moving objects in the scene, which can be used to generate a composite image with a fixed amount of motion blur. This alleviates the need to estimate the direction and extent of motion blur from the coded image, errors in which can reduce the quality of the de-blurred image.

### CROSS-REFERENCE TO PROVISIONAL PATENT APPLICATION

This patent application claims priority under 35 U.S.C. § 119(e) to provisional patent application Ser. No. 61/052,147, entitled “Simulating a Fluttering Shutter from Video Data” which was filed on May 9, 2008, the entire disclosure of which is hereby incorporated by reference.

### TECHNICAL FIELD

Embodiments are generally related to surveillance systems and components thereof. Embodiments are also related to biometric sensors and related devices. Embodiments are also related to the processing of video data.

### BACKGROUND OF THE INVENTION

A number of surveillance and biometric systems are currently being designed and implemented. One example of such a system is CFAIRS (Combined Face and Iris Recognition System), which offers a number of features such as automatic standoff detection and imaging, including dual biometric (e.g., face and iris) capabilities, along with identification and verification offered against a stored database of biometric data. CFAIRS also provides for optional automatic enrollment, near IR illumination and imaging, portable packaging and real-time surveillance and access control, in addition to stand alone or integrated security systems.

To date, most surveillance and biometric systems have been limited by the quality of their input images. There are a number of nuisance factors that may lead to a decrease in performance. Among such factors are motion blur, optical blur, underexposure, and low spatial sampling. Of particular interest to the developers of systems such as, for example, CFAIRS is the difficulty of acquiring sharp pictures of the irises of moving subjects. Moving subjects are also a problem for systems that perform face recognition, as motion-blurred images are more difficult to analyze. In both of these cases, the inability to acquire sharply-focused images of objects in motion is a fundamental limitation. There is, therefore, a need to develop camera systems that are capable of capturing crisp pictures of moving subjects.

One can reduce motion blur by shortening the exposure duration. Such an approach, however, typically results in a reduction of the level of exposure and increases the detrimental effects of noise. In order to avoid these problems, while maintaining a constant level of exposure despite shortening the exposure duration, one must increase the size of the aperture. This results, however, in increased optical blur (i.e., a shallower depth of field), another nuisance factor. Such fundamental trade-offs between motion blur, optical blur, and underexposures are well known to engineers and designers. In order to improve visual surveillance and biometrics, one must look for ways to improve the fundamental abilities of the camera in order to achieve a true gain in performance.

One approach toward these problems can involve the use of fluttering shutter technology, which can be used to improve camera systems by enabling such devices to produce sharp images of moving objects without reducing the total exposure or shortening the exposure duration. In doing so, it offers a fundamental improvement—not simply a trade-off. This can be achieved by initially acquiring or synthesizing an image with coded motion blur. Because uncoded motion blur is equivalent to convolution with a rectangle function, certain spatial frequencies cannot be recovered from that image. Images with coded motion blur can be captured by fluttering the shutter of a custom camera open and closed during the exposure duration or can be synthesized by combining the exposure of several frames from a standard video camera. The fluttering pattern can be selected or synthesized in such a manner as to preserve image content at all spatial frequencies. Given an image with coded blur, a suitably designed sharpening algorithm may be utilized to recover a crisp image from the coded motion-blurred image.

One example of the use of a fluttering shutter (also known as a “flutter shutter”) is disclosed in U.S. Patent Application Publication No. US20070258706A1 entitled “Method for Deblurring Images Using Optimized Temporal Coding Patterns” by Raskar, et al., which is incorporated herein by reference in its entirety. U.S. Patent Application Publication No. US20070258706A1 generally describes a particular technique for implementing a fluttering shutter. One of the problems with the approach described in U.S. Patent Application Publication No. US20070258706A1 is that such a technique integrates the exposure on the image sensor of a still camera, which limits the fluttering pattern due to hardware limitations. As will be disclosed in greater detail herein, an improvement to this concept involves using frames from a standard video camera (unlike US20070258706A1). Such frames can then be utilized to generate one or more composite coded motion-blurred images from which one can derive a sharply-focused image of a moving object. It is believed that such an approach can overcome the problems inherent with systems such as that of US20070258706A1, while offering a number of other improvements, particularly in lowering costs and raising efficiency in the design and implementation of surveillance and biometric systems.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved surveillance and biometric method and system.

It is another aspect of the present invention to provide for a method and system for simulating a fluttering shutter from video data.

The aforementioned aspects and other objectives and advantages can now be achieved as described herein. A method and system is disclosed for simulating a fluttering shutter from video data. In general, composite images can be generated by adding a sequence of video frames, each scaled according to a weight. By selecting an appropriate sequence of weights, the effects of a fluttering shutter can be synthesized with the additional flexibility of being able to use negative and non-binary amplitudes. In addition, video analytic functions, such as background subtraction and tracking, can be used to improve the results of the de-blurring. In particular, the use of background-subtracted frames in generating the composite image prevents background intensities from distorting the de-blurred image. Tracking information can be used to estimate the location and speed of moving objects in the scene, which can be used to generate a composite image with a fixed amount of motion blur. This alleviates the need to estimate the direction and extent of motion blur from the coded image, errors in which can reduce the quality of the de-blurred image. Finally, occlusion detection can be utilized to select which frames should be combined to form the composite frame, selecting only those frames where the moving subject is visible.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a diagram comparing traditional and fluttering shutters, with respect to a preferred embodiment;

FIG. 2 illustrates a diagram depicting iris images with simulated motion blur and their appearance after de-blurring, with respect to a preferred embodiment;

FIG. 3 illustrates a high-level flow chart of operations depicting logical operational steps of a method for simulating a fluttering shutter from video data, in accordance with a preferred embodiment;

FIG. 4 illustrates a block diagram of a data-processing system that may be utilized to implement a preferred embodiment;

FIG. 5 illustrates a block diagram of a computer software system for directing the operation of the data-processing system depicted in FIG. 4; and

FIG. 6 illustrates a graphical representation of a network of data processing systems in which aspects of the present invention may be implemented.

### DETAILED DESCRIPTION

The particular values and configurations discussed in these non-limiting examples can be varied and are cited merely to illustrate at least one embodiment and are not intended to limit the scope thereof.

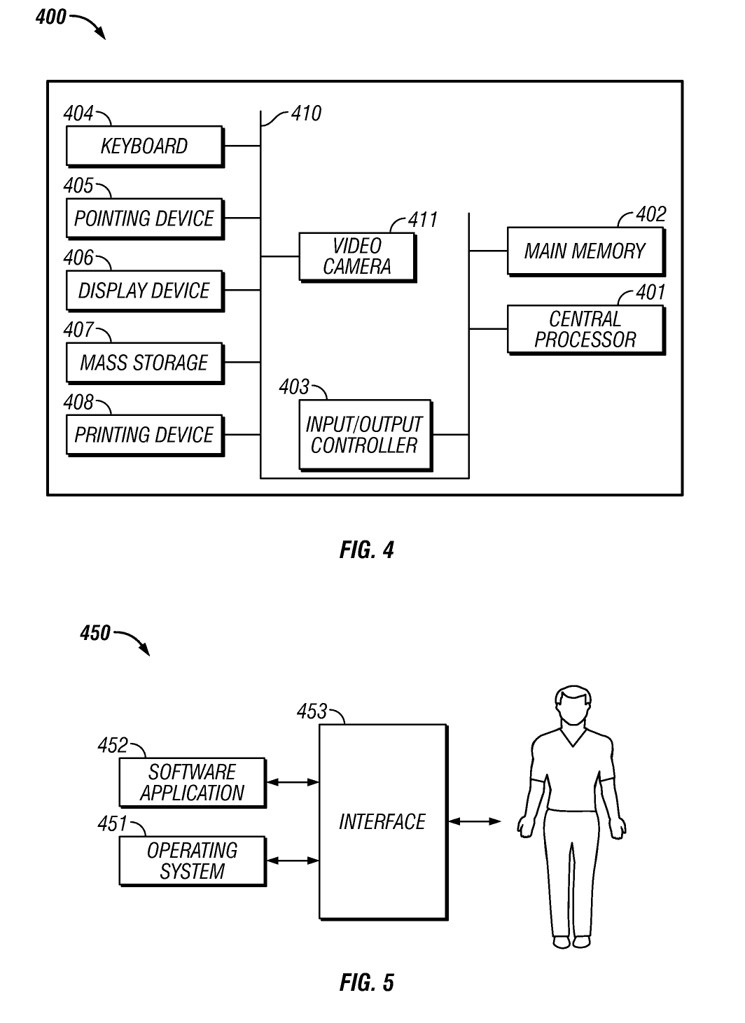

The approach described herein can be utilized to generate composite images by adding a sequence of video frames taken from a video camera such as, for example, video camera 411 depicted in FIG. 4, and then scaling each frame according to a weight. By selecting an appropriate sequence of weights and combining the scaled frames, one can synthesize the effects of a fluttering shutter, with the additional flexibility of being able to use negative and non-binary amplitudes. In addition, video analytic functions, such as background subtraction, tracking, and occlusion detection, can be utilized to improve the results of the de-blurring. In particular, the use of background-subtracted frames in generating the composite image prevents background intensities from distorting the de-blurred image. Tracking information can be used to estimate the location and speed of moving objects in a particular scene, which can then be utilized to generate a composite image with a fixed amount of motion blur. This alleviates the need to estimate the direction and extent of motion blur from the coded image, errors which can reduce the quality of the de-blurred image. Finally, occlusion detection can be utilized to select which frames should be combined to form the composite frame, selecting only those frames where the moving subject is visible.

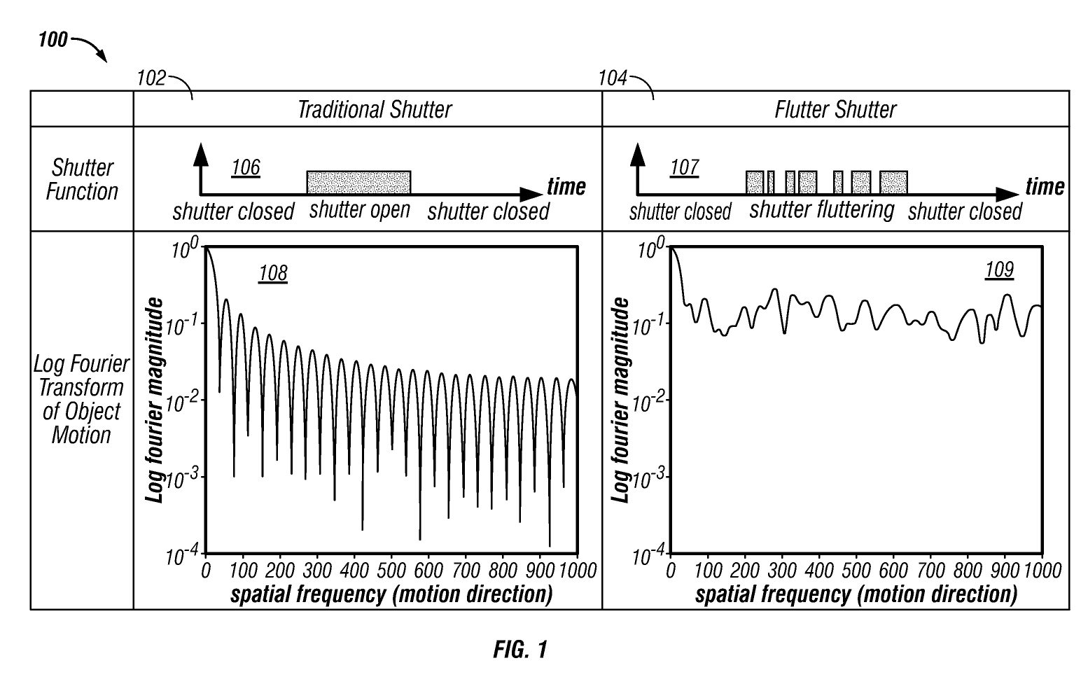

FIG. 1 illustrates a diagram 100 that compares traditional and fluttering shutters. In order to properly motivate the use of a fluttering shutter, one can briefly review the image quality implications of motion blur as seen through a traditional open/closed shutter. In diagram 100, a column 102 includes data related to the use of a traditional shutter and column 104 illustrates data related to the use of a flutter shutter. A graph 106 depicts shutter timing with respect to the use of a traditional shutter. In column 104, a graph 107 illustrates shutter timing with respect to the use of a flutter shutter. A graph 108 is also illustrated in FIG. 1 with respect to column 102, while a graph 109 is depicted with respect to column 104. Graphs 108 and 109 illustrate data indicative of a log Fourier transform of the blur arising from object motion.

Column 102 of FIG. 1 illustrates the timing of a traditional shutter, along with the Fourier transform of the 1D blur in the direction of motion as depicted in graph 108. The Fourier transform data depicted in graph 108 shows that contrast is significantly muted at the middle and high spatial frequencies, and goes to zero at a number of spatial frequencies (the valleys in the Fourier transform). These spatial frequencies are lost when captured through a traditional shutter and post-processing the image cannot recover that information.

In the disclosed approach, on the other hand, one can select a sequence of weights that, when applied to a sequence of video frames and combined, preserves image content at all spatial frequencies and preserves all frequencies at a nearly uniform level of contrast. Thus, column 104 of FIG. 1 (right column) depicts a simplified illustration of flutter shutter timing, along with the Fourier transform of motion blur associated with the shutter pattern. Comparing this to the Fourier transform associated with the traditional shutter (i.e., see graph 108), the flutter shutter (i.e., see graph 109) preserves higher contrast at all spatial frequencies and avoids lost frequencies.

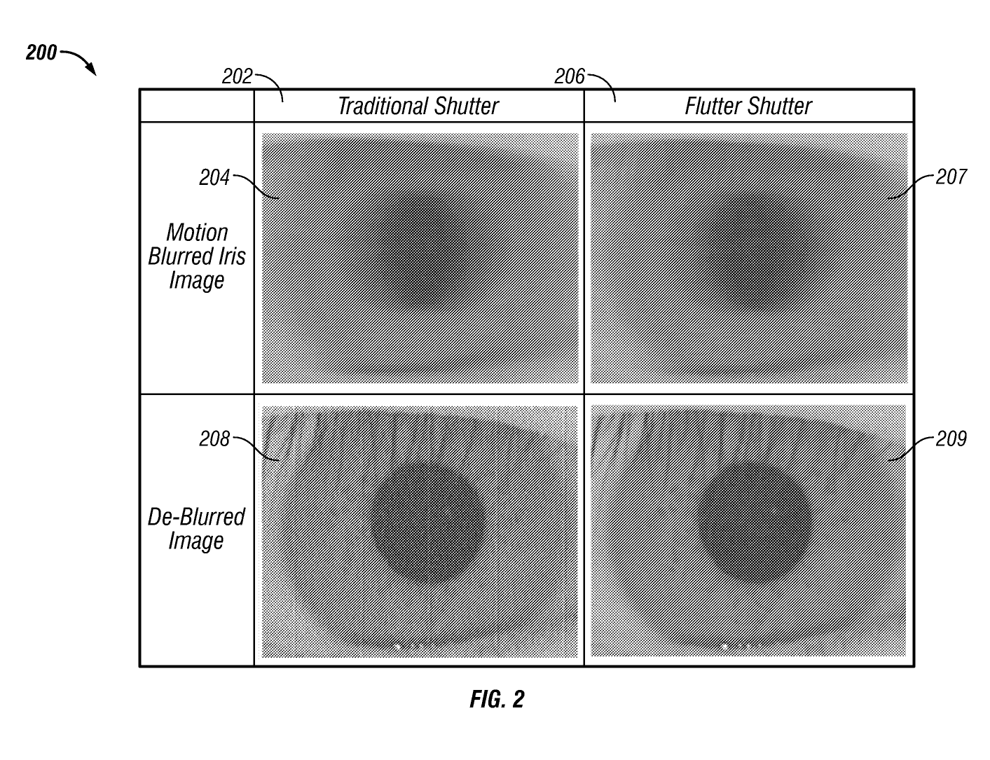

FIG. 2 illustrates a diagram 200 depicting iris images with simulated motion blur and their appearance after de-blurring. in diagram 200 of FIG. 2, two columns are indicated, including a column 202 related to a traditional shutter and a column 206 related to the use of a flutter shutter. In column 202, an image 204 of an iris acquired in the presence of simulated horizontal motion blur through a traditional shutter is illustrated. Image 204 contains little detail in most spatial frequencies, necessitating substantial amplification to achieve the desired contrast. The resulting image 208 contains high levels of noise due to this amplification. Moreover, due to the lack of spectral content at several spatial frequencies, the de-blurred image has artifacts in the form of vertical lines. The right column of diagram 200 therefore illustrates the corresponding motion-blurred image 207 (upper row) and de-blurred image 209 (bottom row) using a simulation of the fluttering shutter.

Though the de-blurred image 207 acquired by the simulated fluttering shutter is of higher visual quality, the primary concern is the ability to match the de-blurred iris image to other images of the same iris. In the course of operation, a biometrics platform incorporating a fluttering shutter can be utilized to compare the de-blurred image to a different image of the same iris, e.g. one acquired during an enrollment process. In order to evaluate the images depicted in FIG. 2 in an operationally-relevant setting, an algorithm may be utilized to perform a comparison between each of the two de-blurred images and a different image of the same eye.

Such an algorithm may be utilized, and for our example in FIG. 2, determines a distance of 0.3670 between the traditional shutter's de-blurred image 208 and the enrollment image. This distance is greater than the current threshold of 0.30, meaning that the de-blurring applied to the traditional shutter image does not recover sufficient detail to enable a match between two images of the same iris. The distance between the flutter shutter's de-blurred image 209 and the enrollment image is, in this example, 0.2795, which is below the distance threshold and does produce a match. As a point of reference, the distance between the enrollment image and the sharply-focused iris image from which the simulated images were derived can also be measured. In this example, that distance of 0.2760 is only slightly smaller than the distance between the de-blurred flutter shutter and enrollment images, meaning that the simulated flutter shutter and de-blurring recover almost all of the details relevant to iris matching.

Note that the images in FIG. 2 were simulated with 1D convolution implemented as a matrix multiplication. The de-blurring was achieved by multiplying the blurred image by the appropriate inverse matrix. In this case, the motion characteristics used to simulate the blur were also used to de-blur the images, obviating the need to estimate motion from the images.

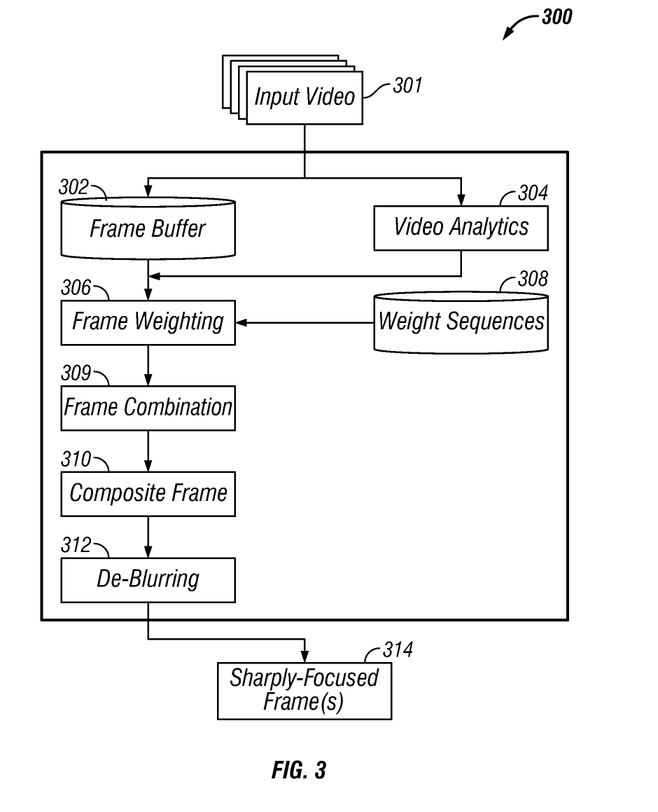

FIG. 3 illustrates a high-level flow chart of operations depicting logical operational steps of a method 300 for simulating a fluttering shutter from video data, in accordance with a preferred embodiment. Method 300 involves the generation and de-blurring of composite images formed by adding a sequence of video frames, each scaled according to a sequence of weights. As indicated at block 301, video images are provided. The operation described at block 301 generally involves capturing video frames using a standard camera. Next, as indicated at block 302, a frame buffer can be implemented to store a selection of recent video images provided via the operation illustrated at block 301. An operation involving video analytics, as described herein, can also be implemented, as depicted at block 304. A frame weighting operation can then be implemented as depicted at block 306, utilizing one or more weight sequences stored in a repository as indicated at block 308. The operation illustrated at block 306 generally involves scaling a subset of the captured video frames from the frame buffer (block 302) according to a sequence of weights to produce a plurality of scaled video frames thereof. The scaled video frames can then be combined at block 309 to generate one or more composite images (block 310) with coded motion blur. Thereafter, the composite image(s) is processed at block 312 to produce a sharply-focused image as illustrated at block 314.

Thus, by selecting an appropriate sequence of weights from the repository at block 308, the effects of a fluttering shutter can be synthesized in blocks 306 and 309, with the additional flexibility of being able to use negative and non-binary amplitudes. In addition, the video analytic functions (e.g., background subtraction, tracking, and occlusion detection) provided via the operation depicted at block 304 can be used to improve the results of the de-blurring. In particular, the use of background-subtracted frames in generating the composite image, as indicated at block 310, can assist in preventing background intensities from distorting the de-blurred image. Tracking information can be used to estimate the location and speed of moving objects in the scene, which can be used to generate a composite image with a fixed amount of motion blur. This alleviates the need to estimate the direction and extent of motion blur from the coded image, errors in which can reduce the quality of the de-blurred image. Finally, occlusion detection can be utilized to select which frames should be combined to form the composite frame, choosing only those frames where the moving subject is visible

FIGS. 4-6 are provided as exemplary diagrams of data processing environments in which embodiments of the present invention may be implemented. It should be appreciated that FIGS. 4-6 are only exemplary and are not intended to assert or imply any limitation with regard to the environments in which aspects or embodiments of the present invention may be implemented. Many modifications to the depicted environments may be made without departing from the spirit and scope of the present invention.

FIG. 4 indicates that the present invention may be embodied in the context of a data-processing system 400 comprising a central processor 401, a main memory 402, an input/output controller 403, a keyboard 404, a pointing device 405 (e.g., mouse, track ball, pen device, or the like), a display device 406, and a mass storage 407 (e.g., hard disk). Additional input/output devices, such as a printing device 408 and/or video camera 411, may be included in the data-processing system 400 as desired. As illustrated, the various components of the data-processing system 400 communicate through a system bus 410 or similar architecture.

FIG. 5 illustrates a computer software system 450 provided for directing the operation of the data-processing system 400. Software system 450, which is stored in system memory 402 and on disk memory 407, includes a kernel or operating system 451 and a shell or interface 453. One or more application programs, such as application software 452, may be “loaded” (i.e., transferred from storage 407 into memory 402) for execution by the data-processing system 400. The data-processing system 400 receives user commands and data through user interface 453. These inputs may then be acted upon by the data-processing system 400 in accordance with instructions from operating module 451 and/or application module 452.

The interface 453, which is preferably a graphical user interface (GUI), also serves to display results, whereupon the user may supply additional inputs or terminate the session. In an embodiment, operating system 451 and interface 453 can be implemented in the context of a “Windows” system or another operating system, such as, for example, one based on Linux, Unix, etc. Application module 452, on the other hand, can include instructions, such as the various operations described herein with respect to the various components and modules described herein, such as, for example, the method 300 depicted in FIG. 3 and the methodology discussed herein with respect to FIGS. 1-2.

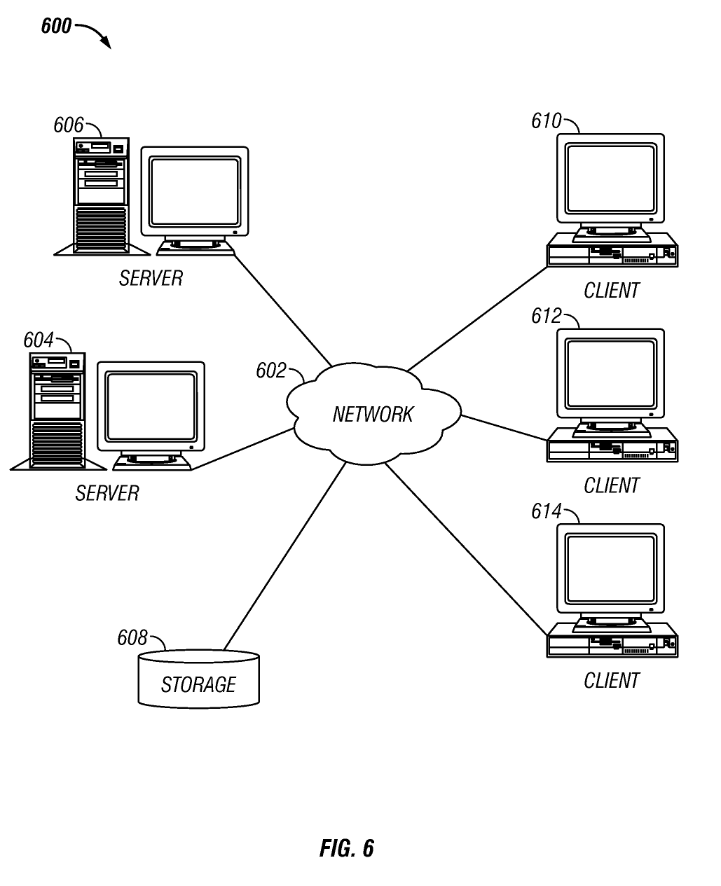

FIG. 6 illustrates a graphical representation of a network of data processing systems in which aspects of the present invention may be implemented. Network data processing system 600 is a network of computers in which embodiments of the present invention may be implemented. Network data processing system 600 contains network 602, which is the medium used to provide communications links between various devices and computers connected together within network data processing apparatus/system 400. Network 602 may include connections, such as wire, wireless communication links, or fiber optic cables.

In the depicted example, server 604 and server 606 connect to network 602 along with storage unit 608. In addition, clients 610, 612, and 614 connect to network 602. These clients 610, 612, and 614 may be, for example, personal computers or network computers. Data-processing system 400, as depicted in FIG. 4, can be, for example, a client such as client 610, 612, and/or 614. Alternatively, data-processing system 400 can be implemented as a server, such as servers 604 and/or 606, depending upon design considerations.

In the depicted example, server 604 provides data, such as boot files, operating system images, and applications to clients 610, 612, and 614. Clients 610, 612, and 614 are clients to server 604 in this particular example. Network data processing system 600 may include additional servers, clients, and other devices not shown. Specifically, clients may connect to any member of a network of servers which provide equivalent content.

In the depicted example, network data processing system 600 can be implemented as the “Internet” with network 602 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 600 also may be implemented as a number of different types of networks, such as for example, an intranet, a local area network (LAN), or a wide area network (WAN). FIG. 6 is intended as an example and not as an architectural limitation for different embodiments of the present invention.

The foregoing description is therefore presented with respect to embodiments of the present invention, which can be embodied in the context of a data-processing system such as data-processing system 400, computer software system 450 and data processing system 600 and network 602, depicted respectively in FIGS. 4-6. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

It will be appreciated that variations of the above-disclosed and other features and functions, or alternatives thereof may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for simulating a fluttering shutter from video data, comprising:
utilizing a video camera to produce a plurality of captured video frames thereof;
scaling a subset of said plurality of captured video frames according to a sequence of weights to produce a plurality of scaled video frames thereof;
combining said plurality of scaled video frames to generate at least one composite image with a coded motion blur; and
processing said at least one composite image to produce a sharply-focused image.

2. The method of claim 1 wherein said sequence of weights contains at least one negative weight.

3. The method of claim 1 wherein said sequence of weights contains at least one non-binary weight.

4. The method of claim 1 further comprising utilizing at least one video analytic function to improve results of a de-blurring operation performed upon said at least one composite image.

5. The method of claim 4 wherein said at least one video analytic function comprises a background subtraction to derive at least one background-subtracted frame with respect to said plurality of video frames.

6. The method of claim 4 wherein said at least one video analytic function comprises tracking to generate tracking information utilized to estimate a location and a speed of said moving subject in a scene, which can be utilized to select said sequence of weights and generate said at least one composite image with a fixed amount of motion blur.

7. The method of claim 4 wherein said at least one video analytic function comprises occlusion detection, which can be utilized to select said subset of said plurality of captured video frames combined to form said at least one composite frame.

8. A system for simulating a fluttering shutter from video data, comprising:
a data bus coupled to said processor; and
a computer-usable medium embodying computer code, said computer-usable medium being coupled to said data bus, said computer program code comprising instructions executable by said processor and configured for:
utilizing a video camera to produce a plurality of captured video frames thereof;
scaling a subset of said plurality of captured video frames according to a sequence of weights to produce a plurality of scaled video frames thereof;
combining said plurality of scaled video frames to generate at least one composite image with a coded motion blur; and
processing said at least one composite image to produce a sharply-focused image.

9. The system of claim 8 wherein said sequence of weights contains at least one negative weight.

10. The system of claim 8 wherein said sequence of weights contains at least one non-binary weight.

11. The system of claim 8 wherein said instructions are further configured for utilizing at least one video analytic function to improve results of a de-blurring operation performed upon said at least one composite image.

12. The system of claim 11 wherein said at least one video analytic function comprises a background subtraction to derive at least one background-subtracted frame with respect to said plurality of video frames.

13. The system of claim 11 wherein said at least one video analytic function comprises tracking to generate tracking information utilized to estimate a location and a speed of said moving subject in a scene, which can be utilized to select said sequence of weights and generate said at least one composite image with a fixed amount of motion blur.

14. The system of claim 11 wherein said at least one video analytic function comprises occlusion detection, which can be utilized to select said subset of said plurality of captured video frames combined to form said at least one composite frame.

15. A computer-usable medium for simulating a fluttering shutter from video data, said computer-usable medium embodying computer program code, said computer program code comprising computer executable instructions configured for:
utilizing a video camera to produce a plurality of captured video frames thereof;
scaling a subset of said plurality of captured video frames according to a sequence of weights to produce a plurality of scaled video frames thereof;
combining said plurality of scaled video frames to generate at least one composite image with a coded motion blur; and
processing said at least one composite image to produce a sharply-focused image.

16. The computer-usable medium of claim 15 wherein said sequence of weights contains at least one negative weight.

17. The computer-usable medium of claim 15 wherein said sequence of weights contains at least one non-binary weight.

18. The computer-usable medium of claim 15 wherein said embodied computer program code further comprises computer executable instructions configured for utilizing at least one video analytic function to improve results of a de-blurring operation performed upon said at least one composite image.

19. The computer-usable medium of claim 18 wherein said at least one video analytic function comprises a background subtraction to derive at least one background-subtracted frame with respect to said plurality of video frames.

20. The computer-usable medium of claim 18 wherein said at least one video analytic function comprises tracking to generate tracking information utilized to estimate a location and a speed of said moving subject in a scene, which can be utilized to select said sequence of weights and generate said at least one composite image with a fixed amount of motion blur.
